(19) United States
(12) Patent Application Publication
(10) Pub. No.: US 2013/0117643 A1
(43) Pub. Date: May 9, 2013

(54) METHOD AND APPARATUS FOR SCRAPING OF DIGITAL MAGAZINE THAT IS EDITED IN LAYERS

(71) Applicant: Samsung Electronics Co., Ltd., Gyeonggi-do (KR)

(72) Inventors: Jae-Chul Yang, Gyeonggi-do (KR); Hee-Seok Jeong, Gyeonggi-do (KR); Kyu-Nam Cho, Seoul (KR)

(73) Assignee: Samsung Electronics Co., Ltd., Gyeonggi-do (KR)

(21) Appl. No.: 13/667,934

(22) Filed: Nov. 2, 2012

(30) Foreign Application Priority Data
Nov. 3, 2011 (KR) 10-2011-0113846

(51) Int. Cl. G06F 17/00

(52) U.S. Cl. 715/202

(57) ABSTRACT

According to one embodiment, a scrapping method of a digital magazine edited in layers is provided. In the method, at least one layer is selected, and content of the selected at least one layer is stored in a scrap book.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Nov. 3, 2011 and assigned Serial No. 10-2011-0113846, the entire disclosure of which is hereby incorporated by reference.

### TECHNICAL FIELD OF THE INVENTION

The present invention generally relates digital magazines, and more particularly, to scraping of a digital magazine that is edited in layers.

### BACKGROUND OF THE INVENTION

Communication devices may provide various services based on the Internet, for example, an electronic mail, a remote computer connection, file transfer, Internet information search, Internet conversation and discussion, an electronic bulletin board, hypertext information viewing, etc.

Among these services, an on-line magazine, i.e., webzine, which is a magazine issued via the Internet, has recently been introduced. The digital magazine does not use a conventional paper medium; rather, it utilizes an Internet medium, and introduces a multimedia factor, and two-way communication with readers to draw users' attention. For example, the digital magazine can show vast and detailed information such as a multimedia image, sounds, attached files, links, text, etc. which have not been seen in a paper, in an interactive way.

A user receives information via the digital magazine. Depending on the situation, it may be useful to scrap information. The scrap denotes storing desired written text, images, or the like so that they may be read or viewed at a later time. However, a scrap function for the existing digital magazine may not function properly.

### SUMMARY OF THE INVENTION

To address the above-discussed deficiencies of the prior art, it is a primary object to provide a digital magazine reader that allows scrapping for a digital magazine that is edited in layers.

Another aspect of the present invention is to provide a method and an apparatus for scrapping a digital magazine that is edited on a layer basis.

Still another aspect of the present invention is to provide a scrapping method and an apparatus thereof, for editing content scrapped from at least one digital magazine to generate content.

In accordance with an aspect of the present invention, a scrapping method of a digital magazine edited in layers is provided. The method includes selecting at least one layer; and storing content of the selected at least one layer in a scrap book according to a user input.

In accordance with another aspect of the present invention, a scrapping apparatus of a digital magazine that is edited in layers is provided. The apparatus includes an input unit configured to output an input signal, an output unit configured to output voice or an image for an output signal, and a controller configured to select at least one layer via the input unit, and store content of the selected at least one layer in the storage.

In the embodiment of the present invention, the controller is configured to select an article layer comprising at least one of a multimedia image, sounds, an attached file, a link, and text via the input unit.

In the embodiment of the present invention, the controller is configured to select a layer subordinating an article layer comprising at least one of a multimedia image, sounds, an attached file, a link, and text via the input unit.

In the embodiment of the present invention, the controller is configured to select grouped layers via the input unit.

In the embodiment of the present invention, the controller is configured to select an entire layer of at least one page via the input unit.

In the embodiment of the present invention, the controller is configured to select an entire layer of pages dealing with related content via the input unit.

In the embodiment of the present invention, the controller is configured to store content of the selected at least one layer for each layer type in the storage,

wherein the layer type comprises at least one of an article layer comprising at least one of a multimedia image, sounds, an attached file, a link, and text, a layer subordinating the article layer, grouped layers, an entire layer of pages dealing with related content, and an entire layer of all pages of a digital magazine.

In the embodiment of the present invention, when a touch point of a touch event via the input unit belongs to one layer, the controller is configured to select the layer; and when the touch point of the touch event via the input unit belongs to a plurality of layers, the controller is configured to select at least one of the layers.

In the embodiment of the present invention, the controller is configured to select at least one of content stored in the storage via the input unit, and edit content comprising the selected at least one content via the input unit and generate the content.

In the embodiment of the present invention, the controller is configured to select one of content stored in the storage via the input unit, and output the selected content to the output unit.

Other aspects, advantages and salient features of the invention will become apparent to those skilled in the art from the following detailed description, which, taken in conjunction with the annexed drawings, discloses embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example digital magazine reader according to an embodiment of the present invention;

FIG. 2 illustrates an example screen of a digital magazine reader showing a page of a digital magazine according to an embodiment of the present invention;

FIG. 3 illustrates an example a layer forming a page of a digital magazine according to an embodiment of the present invention;

FIG. 4 illustrates an example a procedure of scrap according to an embodiment of the present invention;

FIGS. 5 to 9 illustrate example views illustrating user interface screens for the procedure of FIG. 4;

FIG. 10 illustrates an example user interface screen for viewing a scrap book;

FIG. 11 illustrates an example a procedure for generating content according to an embodiment of the present invention; and

FIGS. 12 and 13 illustrates example user interface screens for the procedure of FIG. 11.

Throughout the drawings, like reference numerals will be understood to refer to like parts, components and structures.

### DETAILED DESCRIPTION OF THE INVENTION

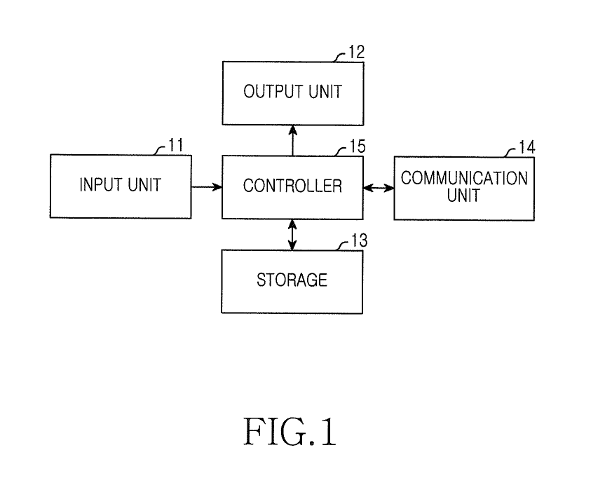

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged computing device. The following description with reference to the accompanying drawings is provided to assist in a comprehensive understanding of embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of embodiments of the present invention are provided for illustration purpose only and not for the purpose of limiting the invention as defined by the appended claims and their equivalents.

Embodiments of the present invention relate to scrapping of a digital magazine. More particularly, embodiments of the present invention provide a scrapping method and an apparatus thereof, capable of scraping a digital magazine edited in layers on a layer basis and producing content using scrapped content.

FIG. 1 illustrates an example digital magazine reader according to an embodiment of the present invention.

The digital magazine reader may be an electronic device such as, but not limited, a portable communication terminal, a personal digital assistant or a notebook computer.

Hereunder, the portable communication is used as the digital magazine reader for the description of the present invention.

Referring to FIG. 1, the digital magazine reader includes an input unit 11, an output unit 12, a storage 13, a communication unit 14, and a controller 15.

The input unit 11 outputs an input signal to the controller 15. For example, the input signal occurs when a button is pressed.

The output unit 12 receives an output signal and outputs the received output signal in the foam of voice or an image under control of the controller 15.

A touch sensitive display, called as a touch screen, may be used as the output unit 603. In this situation, a touch input may be performed via the touch sensitive display.

The digital magazine reader may form a touchscreen integrating the input unit 11 and the output unit 12. Hereinafter, it is assumed that the digital magazine reader displays a digital magazine via the touchscreen and a user performs the scrapping method according to the present invention by generating a signal corresponding to a touch via the touchscreen.

The storage 13 stores a program for controlling an overall operation of the digital magazine reader and various data that is inputted and/or outputted when a control operation of the digital magazine reader is performed. The storage 13 stores content scrapped from a digital magazine, for example, a multimedia image, sounds, attached files, links, text, etc.

The communication unit 14 provides configuration that allows the digital magazine which is a client to communicate with a digital magazine provide server. When a request for a digital magazine from the input unit 11 exists, the controller 15 controls to receive the digital magazine from the digital magazine provide server via the communication unit 14 and output the same to the output unit 12.

The controller 15 controls an overall operation of the digital magazine reader. A scrapping method according to an embodiment of the present invention is described with reference to the drawing.

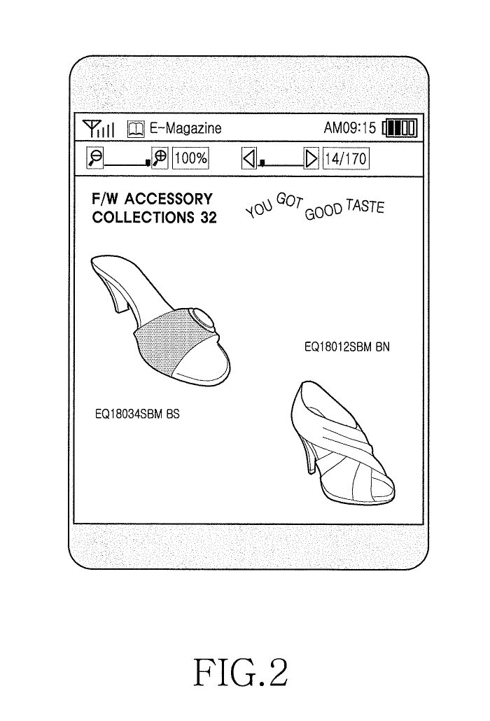

FIG. 2 illustrates an example screen of a digital magazine reader showing a page of a digital magazine according to an embodiment of the present invention. Refuting to FIG. 2, the digital magazine displays a multimedia image, sounds, attached files, links, an article such as text, etc.

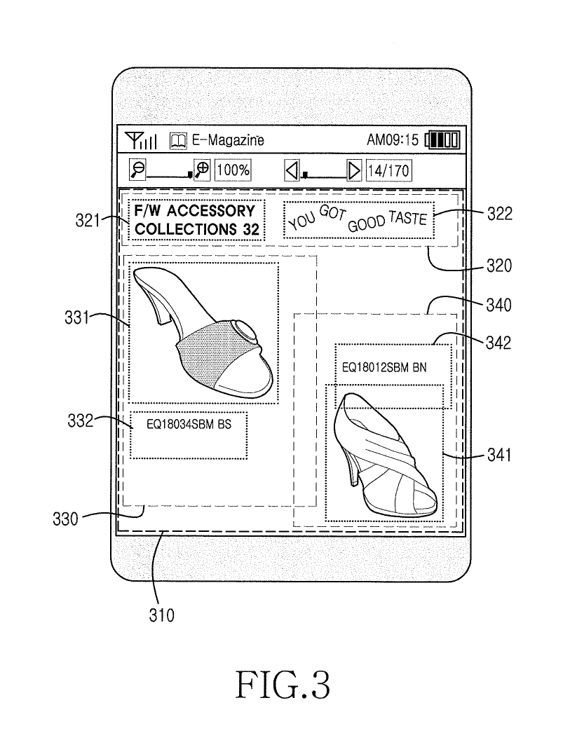

FIG. 3 illustrates and example layer forming a page of a digital magazine according to an embodiment of the present invention. Referring to FIG. 3, a page 310 of a digital page has a configuration where at least one layer is arranged. The layer may be grouped with a different layer or be subordinate to a different layer. For example, a page of the digital magazine includes article layers 321, 322, 331, 332, 341, 342 including at least one of text, images, and the like, and article group layers 320, 330, 340 subordinating the article layers. A first article group layer 320 includes text type article layers 321, 322. In addition, a second article group layer 330 includes an image type article layer 331 and a text type article group layer 332. In addition, a third article group layer 340 includes an image type article layer 341 and a text type article layer 342.

The layers may be placed apart from each other, or placed in a manner to overlap each other. For example, the first article group layer 320 is separated from the second article group layer 330 and the third article group layer 340, and the second article group layer 330 and the third article group layer 340 overlap each other partially. Furthermore, the article layers 321, 322, 331, 332 of the first article group layer 320 and the second article group layer 330 are separated from one another, and the article layers 341, 342 of the third article group layer 340 overlap each other partially.

The layers are edited while a digital magazine is edited, and the server stores information regarding the layers and provides the same to the digital magazine reader.

As described later, the digital magazine reader allows a user to select a layer to scrap. The layer to scrap may be an article layer, an article group layer, a page, a chapter, and entirety. For example, at least one article layer to which a touch point belongs is determined as a scrap object. In addition, at least one article group layer to which a touch point belongs is determined as a scrap object. In addition, an entire layer to which a touch point belongs is determined as a scrap object. In addition, pages including related content or an entire layer of all pages is determined as a scrap object.

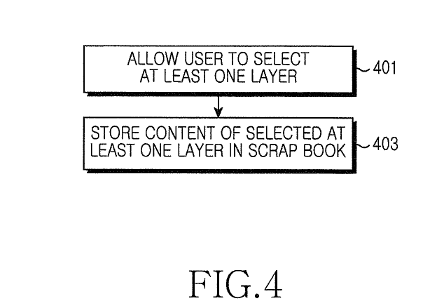

FIG. 4 illustrates an example procedure of scrapping according to an embodiment of the present invention.

Referring to FIG. 4, the controller 15 receive a user input for selecting at least one layer to scrap in step 401. For example, when a relevant touch event occurs, the controller 15 outputs a menu for allowing the user to select one of an article layer, an article group layer, a page, a chapter, and entirety. The controller 15 receives this selection to scrap via the menu. For example, when an article layer is selected via the menu, the controller 15 selects an article layer to which a touch point belongs. In addition, when an article group layer is selected via the menu, the controller 15 selects an article group layer to which a touch point belongs. In addition, when a page is selected via the menu, the controller 15 selects an entire layer of a touched page. In addition, when a chapter is selected via the menu, the controller 15 selects an entire layer of pages dealing with related content. In addition, when entirety is selected via the menu, the controller 15 selects an entire layer of all pages.

Next, the controller 15 stores content of at least one selected layer in a scrap book in step 403.

The method described above in relation with FIG. 4 under of the present invention may be provided as one or more instructions in one or more software modules, or computer programs stored in an electronic device including the digital magazine reader.

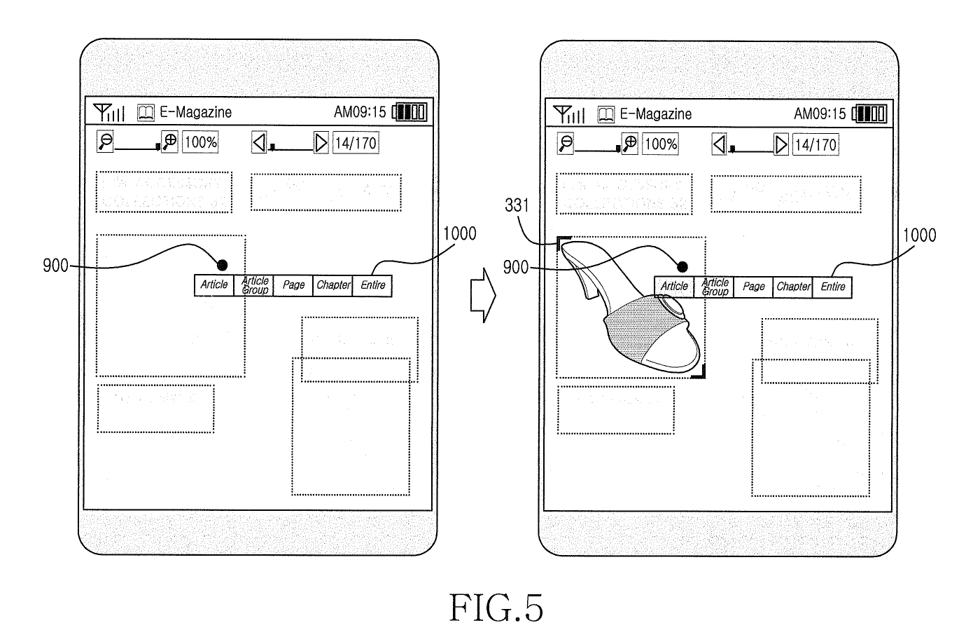

FIGS. 5 to 9 illustrate example user interface screens for the procedure of FIG. 4.

Referring to FIG. 5, when a touch event, for example, a long tap or a double tap occurs, the controller 15 outputs a menu 1000. As described above, the menu provides an article layer, an article group layer, a page, a chapter, and entirety as selection items. When a user selects an article layer in the menu 1000, the controller 15 selects an article layer 331 to which a touch point 900 of the long tap belongs, and stores content of the selected article layer 331 in a scrap book.

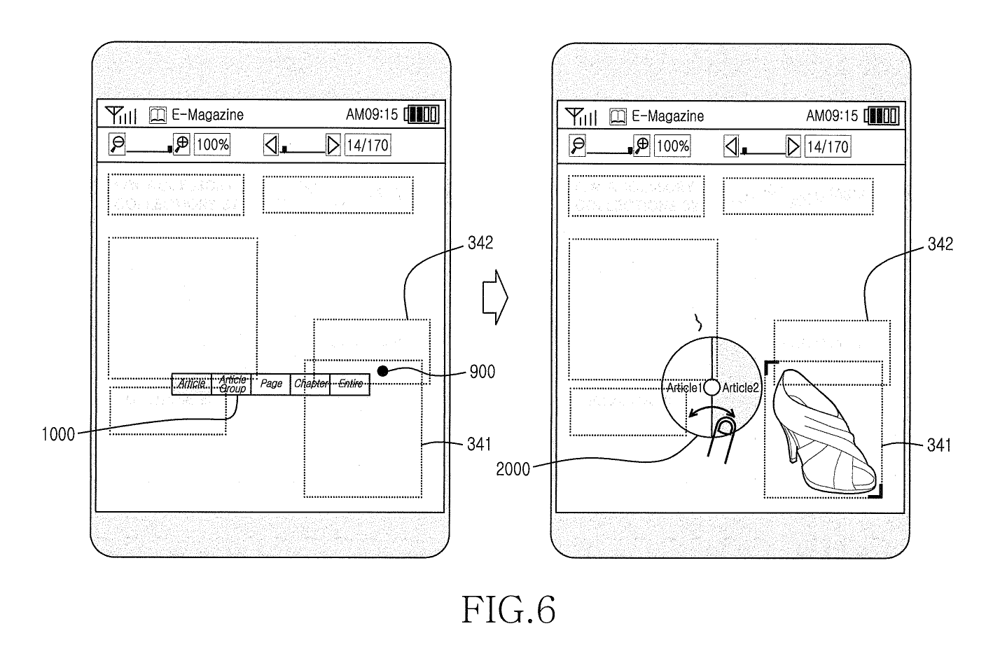

However, as illustrated in FIG. 6, in the case where a plurality of article layers 341, 342 to which the touch point 900 belongs exist, the controller 15 outputs a menu 2000 allowing the user to select one of the article layers 341 and 342. The controller 15 allows the user to select the article layer 341 via the menu 2000, and stores content of the selected article layer 341 in the scrap book.

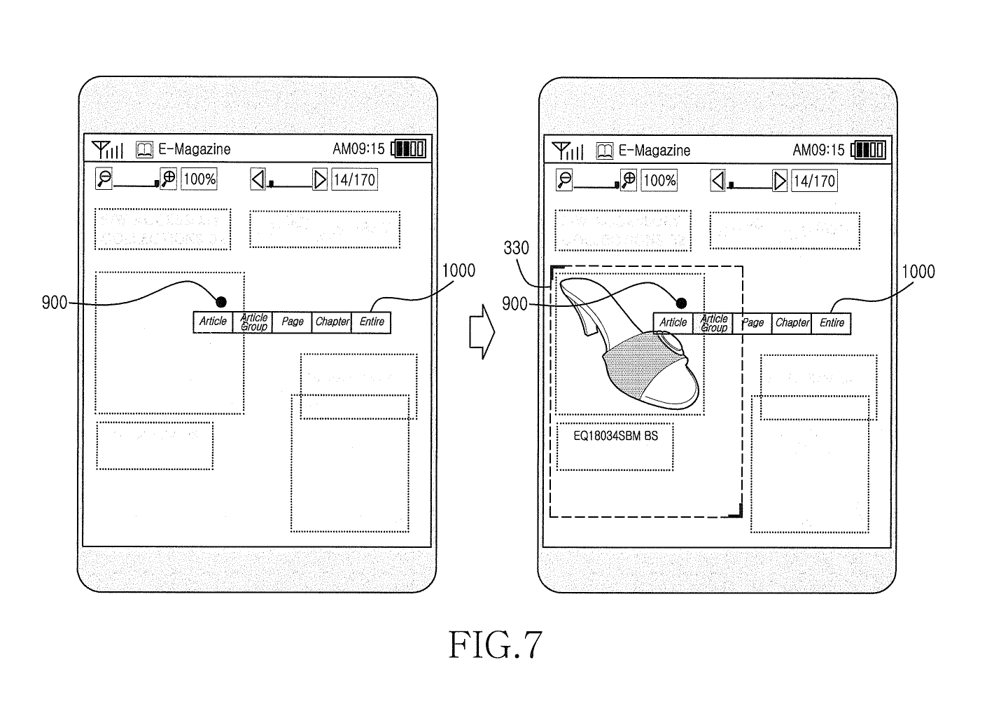

Referring to FIG. 7, when a long tap occurs, the controller 15 outputs the menu 1000. When a user selects an article group layer in the menu 1000, the controller 15 selects an article group layer 330 to which the touch point 900 of the long tap belongs, and stores content of the selected article group layer 330 in the scrap book.

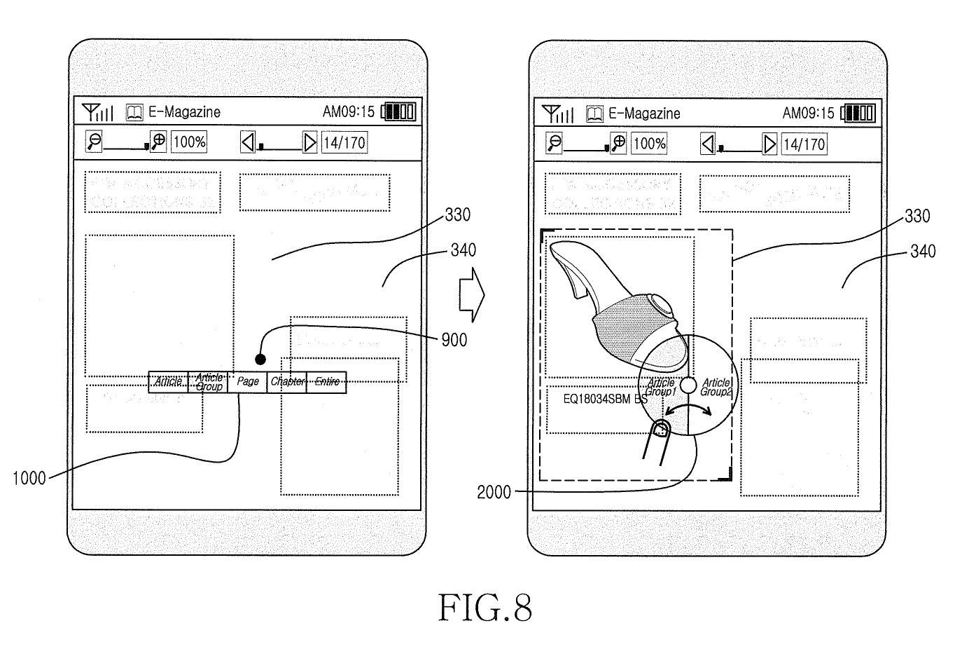

However, as illustrated in FIG. 8, in the case where a plurality of article group layers 330, 340 to which the touch point 900 belongs exist, the controller 15 outputs the menu 2000 allowing the user to select one of the article group layers 330, 340. The controller 15 allows the user to select the article group layer 330 via the menu 2000, and stores content of the selected article group layer 330 in the scrap book.

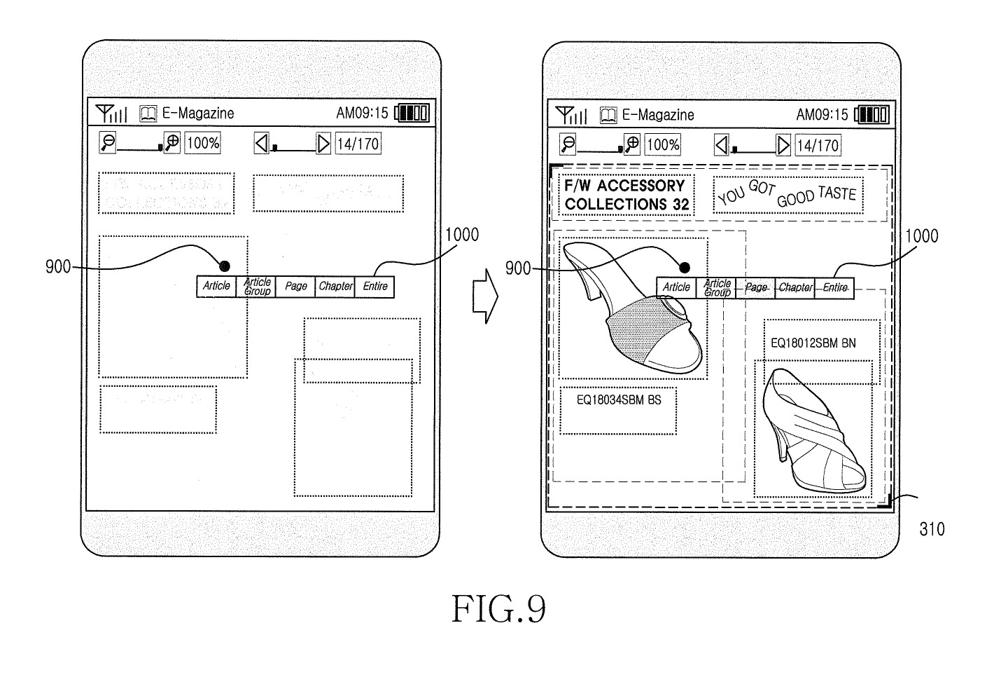

Referring to FIG. 9, when a long tap occurs, the controller 15 outputs the menu 1000. When a user selects a page in the menu 1000, the controller 15 selects an entire layer of a current page 310, and stores content of the selected entire layer in the scrap book. That is, the current page is scrapped.

In addition, though not shown, when the user selects a chapter in the menu 1000, the controller 15 selects an entire layer of pages related to a current page 310, and stores content of the selected entire layer in the scrap book. That is, the pages of related content are scrapped. Furthermore, when the user selects entirety in the menu 1000, the controller 15 selects an entire layer of all pages of a digital magazine, and stores content of the entire layer in the scrap book. That is, all pages of the digital magazine are scrapped.

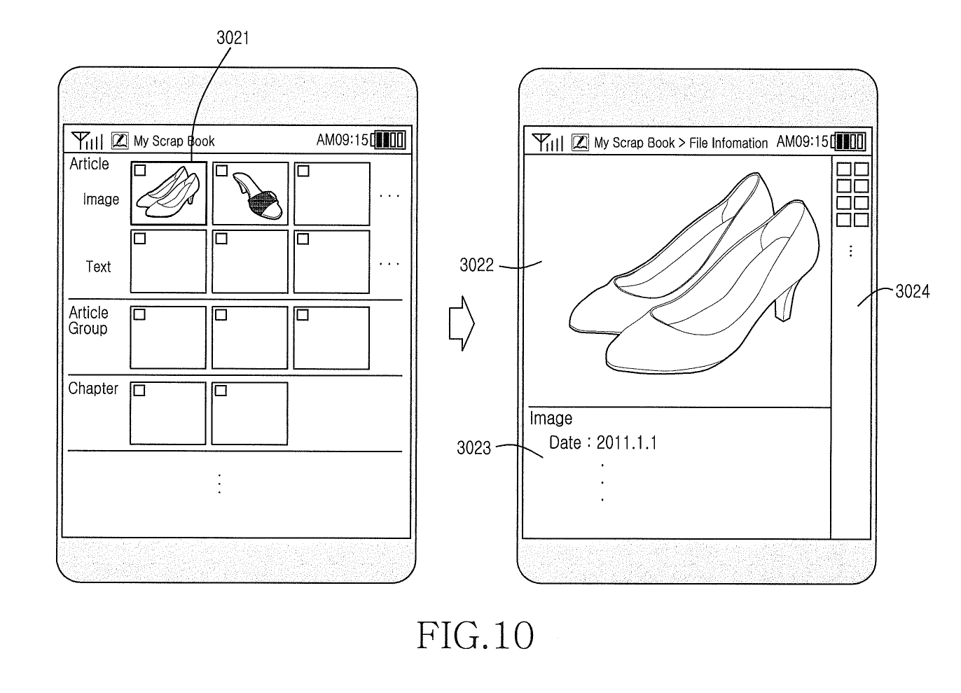

FIG. 10 illustrates an example user interface screen for viewing a scrap book.

Referring to FIG. 10, the scrap book stores objects scrapped according to the scrap method described with reference to FIGS. 2 to 9. As illustrated, the controller 15 may classify and provide objects scrapped for each layer type. Furthermore, the controller 15 may provide a thumbnail, that is, a scrapped object in the form of a small icon that can be previewed. When the user selects an icon 3021, the controller 15 may provide the scrapped object 3021 and information (e.g., generation date, origin, and the like) 3023 of the scrapped object 3021 via a viewer. Furthermore, the controller 15 provides a tool 3024 allowing the user to edit (e.g., size control, color control, text input, and the like) the scrapped object 3021 provided via the viewer.

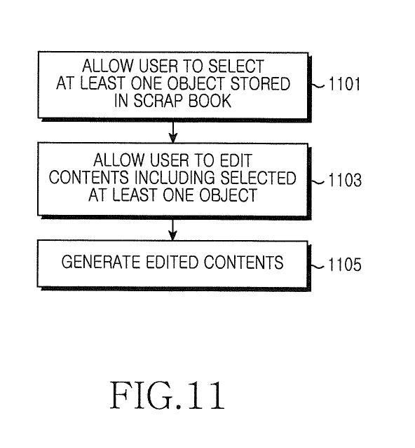

FIG. 11 illustrates an example procedure for generating content according to an embodiment of the present invention.

Referring to FIG. 11, the controller 15 allows a user to select at least one object stored in a scrap book in step 1101. Next, the controller 15 edits content including the selected at least one object in step 1103. Next, the controller 15 generates the edited content in step 1105.

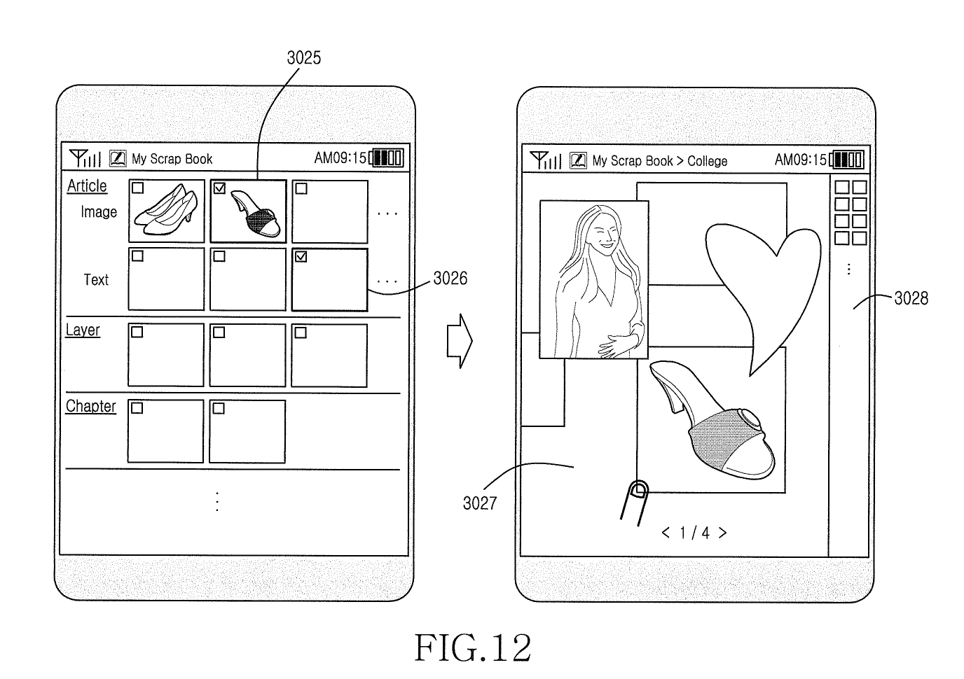

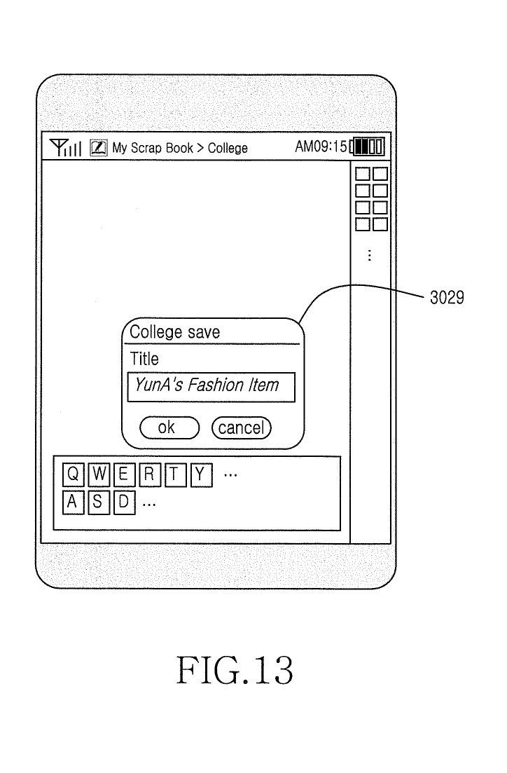

FIGS. 12 and 13 illustrate example user interface screens for the procedure of FIG. 11.

Referring to FIG. 12, the controller 15 allows a user to select scrap objects 3025, 3026 required for producing content via a thumbnail. The controller 15 outputs the selected objects 3025, 3026 via an edit window 3027. The edit window 3027 provides the tool 3024 allowing the user to perform editing such as size control, color control, text input, position movement, etc. Referring to FIG. 13, when requested to store, the controller 15 displays a window 3029 allowing the user to input a filename and complete storing. Content generated via the above process may be shared via a network.

The embodiment of the present invention has been described with reference to an apparatus to which a touchscreen has been applied. However, the present invention is not limited thereto but a scroll method according to an embodiment of the present invention is applicable to an apparatus to which a touchscreen has not been applied.

Consequently, a method and an apparatus for scrapping a digital magazine edited in layers allow a user to scrap the digital magazine on a layer basis, so that scrapping meeting the user's taste may be provided.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

Although the invention has been shown and described with reference to certain embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method of a digital magazine that is edited in layers in an electronic device, the method comprising:
selecting at least one layer according to a user input; and
storing content of the selected at least one layer in a scrap book.

2. The method of claim 1, wherein selecting the at least one layer comprises:
selecting an article layer comprising at least one of a multimedia image, sounds, an attached file, a link, and text according to the user input.

3. The method of claim 1, wherein selecting the at least one layer comprises:
selecting a layer subordinating an article layer comprising at least one of a multimedia image, sounds, an attached file, a link, and text according to the user input.

4. The method of claim 1, wherein selecting at least one layer comprises:
selecting grouped layers according to the user input.

5. The method of claim 1, wherein selecting at least one layer comprises:
selecting an entire layer of at least one page according to the user input.

6. The method of claim 1, wherein selecting at least one layer comprises:
selecting an entire layer of pages dealing with related content according to the user input.

7. The method of claim 1, wherein storing content of the selected at least one layer in the scrap book comprises:
storing content of the selected at least one layer for each layer type,
wherein the layer type comprises at least one of an article layer comprising at least one of a multimedia image, sounds, an attached file, a link, and text, a layer subordinating the article layer, grouped layers, an entire layer of pages dealing with related content, and an entire layer of all pages of a digital magazine.

8. The method of claim 1, wherein selecting at least one layer comprises:
when a touch point of a touch event via a touchscreen belongs to one layer, selecting the layer according to the user input; and
when the touch point of the touch event via the touchscreen belongs to a plurality of layers, selecting at least one of the layers according to the user input.

9. The method of claim 1, further comprising:
selecting at least one of content stored in the scrap book, and editing content comprising the selected at least one content and generate the content according to the user input.

10. The method of claim 1, further comprising:
selecting one of content stored in the scrap book, and outputting the selected content via a viewer according to the user input.

11. An electronic device for a digital magazine that is edited in layers, the device comprising:
an input unit configured to output an input signal;
an output unit configured to output voice or an image for an output signal; and
a controller configured to select at least one layer via the input unit, and store content of the selected at least one layer in the storage according to a user input from the input unit.

12. The device of claim 11, wherein the controller is configured to select an article layer comprising at least one of a multimedia image, sounds, an attached file, a link, and text via the input unit.

13. The device of claim 11, wherein the controller is configured to select a layer subordinating an article layer comprising at least one of a multimedia image, sounds, an attached file, a link, and text via the input unit.

14. The device of claim 11, wherein the controller is configured to select grouped layers via the input unit.

15. The device of claim 11, wherein the controller is configured to select an entire layer of at least one page via the input unit.

16. The device of claim 11, wherein the controller is configured to select an entire layer of pages dealing with related content via the input unit.

17. The device of claim 11, wherein the controller is configured to store content of the selected at least one layer for each layer type in the storage,
wherein the layer type comprises at least one of an article layer comprising at least one of a multimedia image, sounds, an attached file, a link, and text, a layer subordinating the article layer, grouped layers, an entire layer of pages dealing with related content, and an entire layer of all pages of a digital magazine.

18. The device of claim 11, wherein when a touch point of a touch event via the input unit belongs to one layer, the controller is configured to select the layer; and
when the touch point of the touch event via the input unit belongs to a plurality of layers, the controller is configured to select at least one of the layers.

19. The device of claim 11, wherein the controller is configured to select at least one of content stored in the storage via the input unit, and edit content comprising the selected at least one content via the input unit and generate the content.

20. The device of claim 11, wherein the controller is configured to select one of content stored in the storage via the input unit, and output the selected content to the output unit.
